(19) United States
(12) Patent Application Publication
(10) Pub. No.: US 2013/0140288 A1
(43) Pub. Date: Jun. 6, 2013

(54) METHOD AND SYSTEM OF ANNEALING AND REAL-TIME MONITORING BY APPLYING LASER BEAM

(71) Applicants: Hsuan-Yu YU, New Taipei City (TW); Hsiang-Chen Wang, Chiayi City (TW); Ping-Han Wu, Taipei City (TW)

(72) Inventors: Hsuan-Yu YU, New Taipei City (TW); Hsiang-Chen Wang, Chiayi City (TW); Ping-Han Wu, Taipei City (TW)

(73) Assignee: INDUSTRIAL TECHNOLOGY RESEARCH INSTITUTE, Hsinchu (TW)

(21) Appl. No.: 13/330,969

(22) Filed: Dec. 20, 2011

(30) Foreign Application Priority Data
Dec. 2, 2011 (TW) 100144426

(51) Int. Cl. B23K 26/02

(52) U.S. Cl. 219/121.78

(57) ABSTRACT

A method of annealing and real-time monitoring by applying laser beam includes steps of emitting a laser beam and splitting it into a first light beam and a second light beam; irradiating the first light beam along a first path at a to-be-annealed work-piece in order to process annealing for the work-piece; irradiating the second light beam along a second path at the to-be-annealed work-piece; having the to-be-annealed work-piece changed to an annealed work-piece after the process of annealing is completed for the to-be-annealed work-piece; retrieving a characteristic of a characteristic of changes of properties of matter generated from the second light beam irradiated at the to-be-annealed work-piece and the annealed work-piece.

### CROSS-REFERENCE TO RELATED APPLICATIONS

This non-provisional application claims priority under 35 U.S.C. §119(a) on Patent Application No(s). 100144426 filed in Taiwan, R.O.C. on Dec. 2, 2011, the entire contents of which are hereby incorporated by reference.

### BACKGROUND

1. Technical Field

The present disclosure relates to a method and system of annealing and real-time monitoring and more particularly to a method and system of annealing and real-time monitoring by applying laser beam.

2. Related Art

For the industry of displays, because light travelling is obstructed by pixel electrodes in a display panel, the brightness of the display panel is reduced. Therefore, manufacturers usually employ transparent conducting oxide (TCO) materials for the pixel electrodes. Some of the TCO materials, such as indium tin oxide (ITO), have better electric conductivity and light transmittance in the annealed and re-crystallized state than amorphous state. Therefore, such materials processed with annealing are often employed in transparent and electrically conductive circuits. Currently, empirical rule is often employed by manufacturers as a method to find out annealing process parameters of a TCO material, and a predetermined area of the TCO material is processed by annealing with those parameters. The predetermined area is usually referred to electrically conductive traces designed by manufacturers. Because non-crystallized materials are more easily affected by etching than crystallized materials, after the electrically conductive traces are defined on the TCO material, the material with the electrically conductive traces is processed with etching in order to remove the non-crystallized parts. Then, the electrically conductive traces are inspected and tested in order to determine if the electrically conductive traces are completed with the manufacturing process. However, if the electrically conductive traces are found to be defective during the inspection and testing, the entire annealed and etched material will have to be scrapped. Therefore, besides that the TCO material is wasted, the processes of annealing and etching processed previously are also wasted. Chemicals, energy and labor hours required for the processes are also wasted. Therefore, besides a poor defect-free rate, there is also a problem with a waste on the costs.

### SUMMARY

The disclosure provides a method of annealing and real-time monitoring by applying laser beam, the method includes following steps of: emitting a laser beam and splitting it into a first light beam and a second light beam; irradiating the first light beam along a first path at a to-be-annealed work-piece in order to process annealing for the work-piece; irradiating the second light beam along a second path at the to-be-annealed work-piece;

having the to-be-annealed work-piece to change to the annealed work-piece after the process of annealing is completed for the to-be-annealed work-piece; retrieving a characteristic of a characteristic of changes of properties of matter generated from the second light beam irradiated at the to-be-annealed work-piece and the annealed work-piece.

The disclosure provides a system of annealing and real-time monitoring by applying laser beam, and the system comprises a laser source, a light splitting element, a carrying element and a sensing element. The laser source is used for emitting laser beams. The light splitting element is disposed on a path of the laser beam and is used for splitting a laser beam into a first light beam travelling along a first path and a second light beam travelling along a second path. The carrying element is disposed on the first path and the second path for carrying a to-be-annealed work-piece, and for moving the to-be-annealed work-piece to a position irradiated by the first light beam. The sensing element is disposed adjacent to the carrying element, and is used for retrieving a characteristic of a characteristic of changes of properties of matter generated from the second light beam irradiated at the to-be-annealed work-piece and an annealed work-piece.

### BRIEF DESCRIPTION OF THE DRAWINGS

The present disclosure will become more fully understood from the detailed description given herein below for illustration only, and thus are not limitative of the present disclosure, and wherein:

FIG. 1 is a framework of a system of annealing and real-time monitoring by applying laser beam according to an embodiment of the disclosure;

FIG. 2 is a framework of the system of annealing and real-time monitoring by applying laser beam according to another embodiment of the disclosure;

FIG. 3 is a framework of the system of annealing and real-time monitoring by applying laser beam according to another embodiment of the disclosure;

FIG. 4 is a framework of the system of annealing and real-time monitoring by applying laser beam according to another embodiment of the disclosure;

FIGS. 5A and 5B are flow charts of a method of annealing and real-time monitoring by applying laser beam according to an embodiment of the disclosure;

FIG. 6A is a graph of relative relationships between a change of power of a first light beam and different annealing positions of a to-be-annealed work-piece according to an embodiment of the disclosure; and

FIG. 6B is a graph of relative relationships between a change of properties of matter of the to-be-annealed work-piece and the different annealing positions of the to-be-annealed work-piece according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

In view of the abovementioned problems, some embodiments of the disclosure provides a method and system of annealing and real-time monitoring by applying laser beam, so that a problem of waste of costs caused by defects of an annealing process can be solved by the method of annealing and real-time monitoring by applying laser beam.

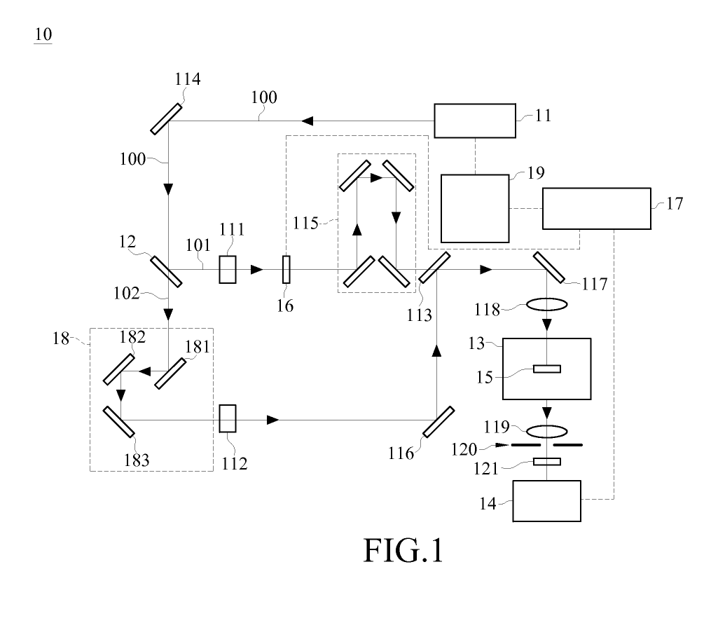

Referring to FIG. 1, it shows a framework of a system 10 of annealing and real-time monitoring by applying laser beam according to an embodiment of the disclosure. The system 10 of annealing and real-time monitoring by applying laser beam of the disclosure comprises a laser source 11, a light splitting element 12, a carrying element 13 and a sensing element 14. The laser source 11 is used for emitting laser beams. The light splitting element 12 is disposed on a beam path 100 of a laser beam and is used for splitting the laser beam into a first light beam travelling along a first path 101 and a second light beam travelling along a second path 102. The carrying element 13 is disposed on a position of the first path 101 where the first path 101 overlaps the second path 102. The carrying element 13 is used for carrying a to-be-annealed work-piece 15, and for moving the to-be-annealed work-piece 15 to an annealing position irradiated by the first light beam and the second light beam. The sensing element 14 is disposed adjacent to the carrying element 13, and is used for sensing a characteristic of changes of properties of matter generated from the second light beam irradiated at the to-be-annealed work-piece 15 or an annealed work-piece. In this embodiment, the sensing element 14 is disposed at a position after the first path 101 and the second path 102 penetrating through the to-be-annealed work-piece 15.

Furthermore, the system 10 further comprises a chopper 16, a locking amplifier 17, an adjusting element 18 and a control element 19. The chopper 16 is disposed on the first path 101 for modulating the first light beam. The locking amplifier 17 is connected to the chopper 16 and the sensing element 14. The locking amplifier 17 is used for processing optical signals of the second light beam modulated by the first light beam. The adjusting element 18 is disposed on the second path 102 and is used for adjusting the beam path length of the second path 102. The control element 19 is connected to the locking amplifier 17 and the adjusting element 18, and is used for controlling the adjusting element 18 to adjust the beam path length of the second path 102 according to a comparison result of the first light beam path length and the second light beam path length. The adjusting element 18 includes, but is not limited to, multiple mirrors 181, 182 and 183. The minors 182 and 183 are movably disposed on the second path 102. The beam path length of the second path 102 can be adjusted by the control element 19 by adjusting the positions of the minors 182 and 183.

Because the control element 19 is connected to the laser source 11, the emitting of laser beams can be controlled by it. Because the control element 19 is connected to the carrying element 13, the to-be-annealed work-piece 15 can be controlled to move to a position irradiated by the first light beam and the second light beam. Because the control element 19 is connected to the locking amplifier 17, whether the work-piece is finished with annealing can be determined by it according to a characteristic of changes of properties of matter sensed by the sensing element 14. The characteristic of changes of properties of matter are, for example, light transmittance or transmitted intensity.

Furthermore, the system 10 further comprises a first laser energy modulator 111 and a second laser energy modulator 112. The first laser energy modulator 111 is disposed on the first path 101 and is used for adjusting the power of the first light beam irradiating at the to-be-annealed work-piece 15. The second laser energy modulator 112 is disposed on the second path 102 and is used for adjusting the power of the second light beam irradiating at the to-be-annealed work-piece 15.

In this embodiment, the system 10 can further comprise a light converging element 113. The light converging element 113 is disposed at an intersecting point of the first path 101 and the second path 102, and is used for converging the first light beam and the second light beam to irradiate at the to-be-annealed work-piece 15.

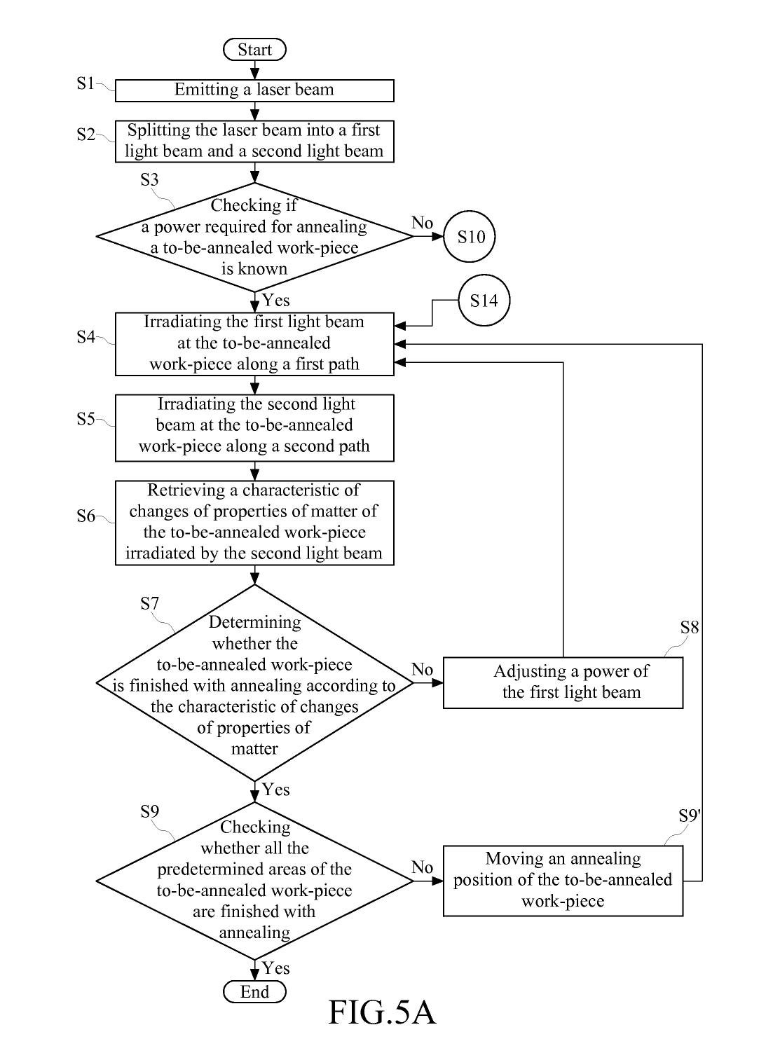

Referring to FIGS. 5A and 5B and cooperating with FIG. 1 for the below descriptions, the method of annealing and real-time monitoring by applying laser beam for using the system 10 in FIG. 1 is described hereafter. FIGS. 5A and 5B are flow charts of the method of annealing and real-time monitoring by applying laser beam according to an embodiment of the disclosure. In step S1, a laser beam emitted by the laser source 11 is a series of pulses with a frequency. The laser beam travels along the path 100, and irradiates at the light splitting element 12 after being reflected by a first minor 114. In step S2, the series of pulses are split into a plurality of first pulses of the first light beam and a plurality of second pulses of the second light beam by the light splitting element 12. The first pulses of the first light beam travel along the first path 101 and pass through the first laser energy modulator 111, the chopper 16 and a set of second minors 115, then irradiating at the light converging element 113. The beam path length of the first path 101 can be adjusted by the set of second mirrors 115 according to requirements. The second pulses of the second light beam travel along the second path 102 and pass through the adjusting element 18, the second laser energy modulator 112 and a fourth mirror 116, then irradiating at the same position of the light converging element 113. By converging the first path 101 and the second path 102 by the light converging element 113, both the first pulses of the first light beam and the second pulses of the second light beam are irradiating at a third minor 117. The first pulses and the second pulses are then reflected to a first focal lens 118 by the third minor 117. The chromatic aberrations, the focal lengths and the focuses of the first light beam and the second light beam are controlled by the first focal lens 118. Then, the first light beam and the second light beam are irradiated at the to-be-annealed work-piece 15. In this embodiment, the light permeable to-be-annealed work-piece 15 is carried by the carrying element 13. The second light beam is irradiated at a second focal lens 119 by passing through the to-be-annealed work-piece 15, and then irradiated at the sensing element 14 through an iris 120 and a polarizer 121. The focal length of the second light beam can be controlled by the second focal lens 119. The iris 120 is used for adjusting the outputted energy intensities of the first light beam and the second light beam which pass through the iris 120. The polarizer 121 is used for obstructing the passage of the first light beam and letting the second light beam to pass through.

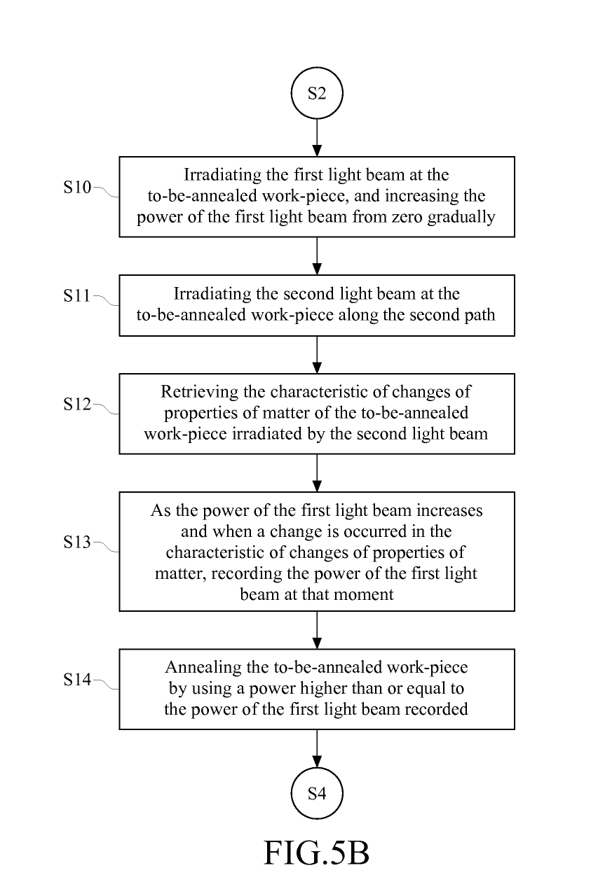

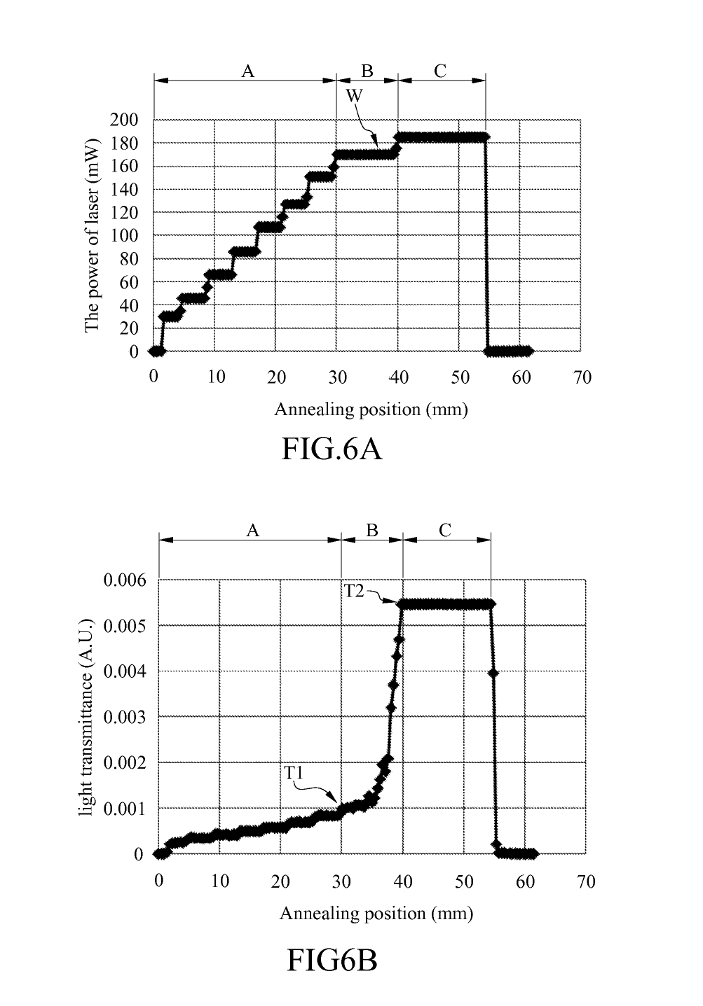

Referring to FIGS. 1, 5A and 5B again, in step S3, checking if a power required for annealing the to-be-annealed work-piece 15 is known by the control element 19. If the power is not known yet, then the process goes to step S10 as shown in FIG. 5B. Referring to FIGS. 6A and 6B at the same time, FIG. 6A is a graph of relative relationships between a change of power of the first light beam and different annealing positions of the to-be-annealed work-piece 15 according to an embodiment of the disclosure, and FIG. 6B is a graph of relative relationships between changes of property of matter of the to-be-annealed work-piece 15 and different annealing positions of the to-be-annealed work-piece 15 according to an embodiment of the disclosure. The to-be-annealed work-piece 15 is, for example, a film of indium tin oxide (ITO). The a characteristic of changes of properties of matter of the to-be-annealed work-piece 15 is an intensity of light transmittance of the second light beam which passes through the to-be-annealed work-piece 15 and is retrieved by the sensing element 14. In step S10, the to-be-annealed work-piece 15 is placed on the carrying element 13, and the power of the first light beam gradually increased from zero by the first laser energy modulator 111. The to-be-annealed work-piece 15 is moved by the carrying element 13 synchronously in corresponding to an increase of the power of the first light beam. In other embodiments, the to-be-annealed work-piece 15 is not moved by the carrying element 13, and a relationship between the intensity of light transmittance and corresponding time and a relationship between the power of the first light beam and corresponding time are recorded. Furthermore, the power of the second light beam is reduced below a certain value by the second laser energy modulator 112 in order to avoid the to-be-annealed work-piece 15 being annealed by the second light beam. Then, the to-be-annealed work-piece 15 is irradiated by the first pulses of the first light beam along the first path 101. In step S11, the to-be-annealed work-piece 15 is irradiated by the second pulses of the second light beam along the second path 102. In step S12, the intensity of light transmittance of the second pulses of the second light beam transmitting through the to-be-annealed work-piece 15 is sensed by the sensing element 14. Thereby, the to-be-annealed work-piece 15 is irradiated by the second pulses of the second light beam right after the to-be-annealed work-piece 15 is irradiated by the first pulses of the first light beam, so that the effects caused by irradiating at the to-be-annealed work-piece 15 by the first pulses can be retrieved in real-time.

In step S13, in a process of a gradual increase of the power of the first light beam as laser pulses are generated, as illustrated in section A of FIGS. 6A and 6B, even though the power of the first pulses of the first light beam is increasing gradually, the intensity of light transmittance of the to-be-annealed work-piece 15 is increasing mildly. But when the power of the first pulses of the first light beam reaches 170 mW, as illustrated in section B of FIGS. 6A and 6B, the intensity of light transmittance of the to-be-annealed work-piece 15 is changed significantly. Even though the power of the first pulses of the first light beam is maintained at 170 mW, the intensity of light transmittance of the to-be-annealed work-piece 15 is increased from an initial intensity of light transmittance T1 of 0.001 A.U. to a terminal intensity of light transmittance T2 of 0.0055 A.U. Because the light transmittance of annealed and re-crystallized indium tin oxide (ITO) is a lot higher than that of non-annealed and non-crystallized indium tin oxide (ITO), the power of the first light beam employed in section B is considered to be the power which can have indium tin oxide (ITO) annealed and re-crystallized. At this point, a power W of the first light beam is recorded for the subsequent annealing process of the entire work-piece. Furthermore, the initial intensity of light transmittance T1 and the terminal intensity of light transmittance T2 of section B can also be recorded. An average value of the intensity of light transmittance acquired by averaging out the initial intensity of light transmittance T1 and the terminal intensity of light transmittance T2 can be used as a reference for subsequently determining whether the work-piece is finished with annealing. Then, in step S14, as shown in section C of FIGS. 6A and 6B, the to-be-annealed work-piece 15 is annealed by using a power higher than or equal to the power W of the first light beam recorded.

Referring to FIGS. 1, 5A and 5B again, in step S4, the to-be-annealed work-piece 15 is irradiated by the first pulses of the first light beam along the first path 101, so that one of the annealing positions of predetermined areas of the to-be-annealed work-piece 15 is annealed. In this embodiment, the predetermined areas are the positions where the electrically conductive traces are located. In step S5, the same position of the to-be-annealed work-piece 15 is irradiated by the second pulses of the second light beam along the second path 102. In step S6, the intensity of light transmittance of the second pulses of the second light beam irradiating at the to-be-annealed work-piece 15 is retrieved by the sensing element 14. In step S7, it is determined that if the to-be-annealed work-piece 15 is finished with annealing according to the characteristic of changes of properties of matter. The change of properties of matter of most light permeable materials is referred to the intensity of light transmittance being higher than an average intensity of light transmittance after annealing is finished. If the intensity of light transmittance is lower than the average value of the intensity of light transmittance, the to-be-annealed work-piece 15 is determined to be unfinished with annealing, and then the process goes to step S8. In step S8, the parameters of the first light beam are adjusted. For example, the power of the first light beam is increased. Then, the process returns to step S4. In step S4, the annealing position of the to-be-annealed work-piece 15 is irradiated at again by the first light beam. If the intensity of light transmittance is higher than the average value of the intensity of light transmittance, it is determined that the annealing position of the to-be-annealed work-piece 15 is finished with annealing, and the process goes to step S9. In step S9, it is determined that if all the predetermined areas of the to-be-annealed work-piece 15 are finished with annealing. If there are predetermined areas which have not finished with annealing, the process goes to step S9′. In step S9′, an annealing position of the to-be-annealed work-piece 15 by the carrying element 13 is moved, and the next annealing position of the to-be-annealed work-piece 15 is annealed by the next first pulse. If all the predetermined areas of the to-be-annealed work-piece 15 are finished with annealing, the annealing process of the to-be-annealed work-piece 15 is finished and therefore, the to-be-annealed work-piece 15 is changed to an annealed work-piece.

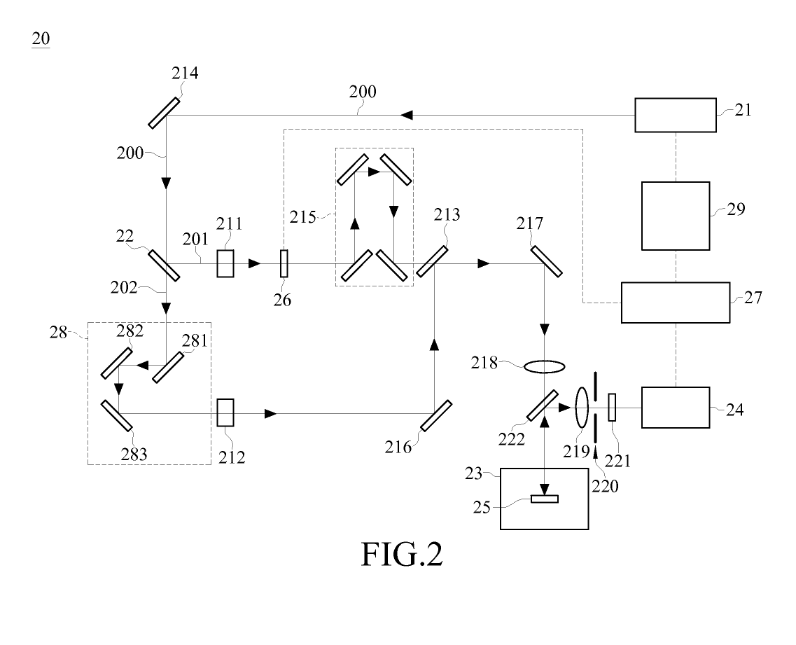

Referring to FIG. 2, it shows a framework of a system 20 of annealing and real-time monitoring by applying laser beam according to another embodiment of the disclosure. The system 20 of annealing and real-time monitoring by applying laser beam of the disclosure comprises a laser source 21, a light splitting element 22, a carrying element 23 and a sensing element 24. The laser source 21 is used for emitting laser beams. The light splitting element 22 is disposed on a beam path 200 of a laser beam and is used for splitting the laser beam into a first light beam travelling along a first path 201 and a second light beam travelling along a second path 202. The carrying element 23 is disposed on a portion of the first path 201 where the first path 201 overlaps the second path 202. The carrying element 23 is used for carrying a to-be-annealed work-piece 25, and for moving the to-be-annealed work-piece 25 to an annealing position irradiated by the first light beam and the second light beam. The sensing element 24 is disposed adjacent to the carrying element 23, and is used for retrieving a characteristic of changes of properties of matter generated from the second light beam irradiated at the to-be-annealed work-piece 25 or an annealed work-piece. In this embodiment, the sensing element 24 is disposed on the second path 202 at a position where it is reflected by the to-be-annealed work-piece 25.

Furthermore, the system 20 further comprises a chopper 26, a locking amplifier 27, an adjusting element 28 and a control element 29. The chopper 26 is disposed on the first path 201 for modulating the first light beam. The locking amplifier 27 is connected to the chopper 26 and the sensing element 24. The locking amplifier 27 is used for processing optical signals of the second light beam modulated by the first light beam. The adjusting element 28 is disposed on the second path 202 and is used for adjusting the beam path length of the second path 202. The control element 29 is connected to the locking amplifier 27 and the adjusting element 28, and is used for controlling the adjusting element 28 to adjust the beam path length of the second path 202 according to a comparison result of the first light beam path length and the second light beam path length. The adjusting element 28 includes, but is not limited to, a plurality of mirrors 281, 282 and 283. The minors 282 and 283 are movably disposed on the second path 202. The beam path length of the second path 202 can be adjusted by the control element 29 by adjusting the positions of the mirrors 282 and 283.

Because the control element 29 is connected to the laser source 21, the emitting of laser beams can be controlled by it. The control element 29 is connected to the carrying element 23 for moving the to-be-annealed work-piece 25 to a position irradiated by the first light beam and the second light beam. The control element 29 is connected to the locking amplifier 27 for determining whether the work-piece is finished with annealing according to the characteristic of changes of properties of matter retrieved by the sensing element 24. The characteristic of changes of properties of matter are, for example, reflectivity or intensity of reflection.

Furthermore, the system 20 further comprises a first laser energy modulator 211 and a second laser energy modulator 212. The first laser energy modulator 211 is disposed on the first path 201 and is used for adjusting the power of the first light beam irradiating at the to-be-annealed work-piece 25. The second laser energy modulator 212 is disposed on the second path 202 and is used for adjusting the power of the second light beam irradiating at the to-be-annealed work-piece 25.

In this embodiment, the system 20 can further comprise a light converging element 213. The light converging element 213 is disposed at an intersecting point of the first path 201 and the second path 202, and is used for converging the first light beam and the second light beam to irradiate at the to-be-annealed work-piece 25. The system 20 further comprise a beam splitter 222 disposing between the light converging element 213 and the carrying element 23. After the first light beam and the second light beam are converged by the light converging element 213, they are both penetrated through the beam splitter 222 to irradiate at the to-be-annealed work-piece 25. The second light beam is irradiated at the beam splitter 222 after being reflected by the to-be-annealed work-piece 25, and is then reflected to the sensing element 24 by the beam splitter 222.

Referring to FIGS. 5A and 5B and cooperating with FIG. 2 for the below descriptions, the method of annealing and real-time monitoring by applying laser beam for using the system 20 in FIG. 2 is described hereafter. FIGS. 5A and 5B are flow charts of the method of annealing and real-time monitoring by applying laser beam according to an embodiment of the disclosure. In step S1, a laser beam emitted by the laser source 21 is a series of pulses with a frequency. The laser beam travels along the beam path 200, and irradiates at the light splitting element 22 after being reflected by the first mirror 214. In step S2, the series of the pulses are split into a plurality of first pulses of the first light beam and a plurality of second pulses of the second light beam by the light splitting element 22. The first pulses of the first light beam travel along the first path 201 and pass through the first laser energy modulator 211, the chopper 26 and a set of second mirrors 215, then irradiating at the light converging element 213. The beam path length of the first path 201 can be adjusted by the set of second mirrors 215 according to requirements. The second pulses of the second light beam travel along the second path 202 and pass through the adjusting element 28, the second laser energy modulator 212 and a fourth mirror 216, then irradiating at the same position of the light converging element 213. By converging the first path 201 and the second path 202 by the light converging element 213, both the first pulses of the first light beam and the second pulses of the second light beam are irradiating at a third minor 217. The first pulses and the second pulses are then reflected to a first focal lens 218 by the third mirror 217. The chromatic aberrations, the focal lengths and the focuses of the first light beam and the second light beam are controlled by the first focal lens 218. Then, both the first light beam and the second light beam pass through the beam splitter 222 and irradiated at the carrying element 23. The second light beam is irradiated at the beam splitter 222 after being reflected by the to-be-annealed work-piece 25, and is then reflected to the sensing element 24 by the beam splitter 222. In this embodiment, the second light beam is firstly reflected to the second focal lens 219 by the beam splitter 222, and then irradiated at the sensing element 24 through an iris 220 and a polarizer 221. The focal length of the second light beam can be controlled by the second focal lens 219, and the iris 220 is used for adjusting outputted energy intensities of the first light beam and the second light beam which pass through the iris. The polarizer 221 is used for obstructing the passage of the first light beam and letting the second light beam to pass through.

Referring to FIGS. 2, 5A and 5B again, in step S3, checking if a power required for annealing the to-be-annealed work-piece 25 is known by the control element 29. If the power is not known yet, then the process goes to step S10 as shown in FIG. 5B. The change of the property of matter of the to-be-annealed work-piece 25 is an intensity of reflection of the second light beam which is reflected by the to-be-annealed work-piece 25 and is retrieved by the sensing element 24. In step S10, the to-be-annealed work-piece 25 is placed on the carrying element 23, and the power of the first light beam is increased gradually from zero by the first laser energy modulator 211. The to-be-annealed work-piece 25 is moved by the carrying element 23 synchronously in corresponding to an increase of the power of the first light beam. In other embodiments, the to-be-annealed work-piece 25 is not moved by the carrying element 23, and a relationship between the intensity of light transmittance and corresponding time and a relationship between the power of the first light beam and corresponding time are recorded Furthermore, the power of the second light beam is reduced below a certain value by the second laser energy modulator 212, in order to avoid the to-be-annealed work-piece 25 being annealed by the second light beam. Then, the to-be-annealed work-piece 25 is irradiated by the first pulses of the first light beam along the first path 201. In step S11, the to-be-annealed work-piece 25 is irradiated by the second pulses of the second light beam along the second path 202. In step S12, the intensity of reflection of the second pulses of the second light beam being reflected by the to-be-annealed work-piece 25 is sensed by the sensing element 24. Thereby, the to-be-annealed work-piece 25 is irradiated by the second pulses of the second light beam right after the to-be-annealed work-piece 25 is irradiated by the first pulses of the first light beam, so that the effects caused by irradiating at the to-be-annealed work-piece 25 by the first pulses can be retrieved in real-time.

In step S13, in a process of a gradual increase of the power of the first light beam as laser pulses are generated, when a change is occurred in the intensity of reflection, recording the power of the first light beam at this moment for the subsequent annealing of the entire to-be-annealed work-piece 25. Furthermore, an initial intensity of reflection and a terminal intensity of reflection can also be recorded when a change is occurred in the intensity of reflection. An average value of the intensity of reflection acquired by averaging out the initial intensity of reflection and the terminal intensity of reflection can be used as a reference for subsequently determining whether the work-piece is finished with annealing. Then, in step S14, the to-be-annealed work-piece 25 is annealed by using a power higher than or equal to the power of the first light beam recorded.

Then, in step S4, the to-be-annealed work-piece 25 is irradiated by the first pulses of the first light beam along the first path 201, so that one of the annealing positions of predetermined areas of the to-be-annealed work-piece 25 is annealed. In this embodiment, the predetermined areas are the positions where the electrically conductive traces are located. In step S5, the same position of the to-be-annealed work-piece 25 is irradiated by the second pulses of the second light beam along the second path 202. In step S6, the intensity of reflection of the second pulses of the second light beam irradiating at the to-be-annealed work-piece 25 is retrieved by the sensing element 24. In step S7, it is determined that if the to-be-annealed work-piece 25 is finished with annealing according to the characteristic of changes of properties of matter. The change of properties of matter of some reflecting materials is referred to the intensity of reflection being higher than an average intensity of reflection after annealing is finished. But for some reflecting materials, the change of properties of matter is referred to the intensity of reflection of the reflecting material being lower than an average intensity of reflection after annealing is finished. If the difference between the intensity of reflection and the terminal intensity of reflection is larger than a difference between the average intensity of reflection and the terminal intensity of reflection, then the to-be-annealed work-piece 25 is determined to be unfinished with annealing. Then, the process goes to step S8. In step S8, parameters of the first light beam are adjusted. For example, the power of the first light beam is increased. Then, the process returns to step S4. In step S4, the annealing position of the to-be-annealed work-piece 25 is irradiated again by the first light beam again. If a difference between the intensity of reflection and the initial intensity of reflection is larger than a difference between an average value of the intensity of reflection and the initial intensity of reflection, it is determined that the annealing position of the to-be-annealed work-piece 25 have been finished with annealing, and the process goes to step S9. In step S9, it is determined that if all the predetermined areas of the to-be-annealed work-piece 25 are finished with annealing. If there are predetermined areas which have not finished with annealing, the process goes to step S9′. In step S9′, an annealing position of the to-be-annealed work-piece 25 is moved by the carrying element 23, and the next annealing position of the to-be-annealed work-piece 25 is annealed by the next first pulse. If all the predetermined areas of the to-be-annealed work-piece 25 are finished with annealing, the annealing process of the to-be-annealed work-piece 25 is finished and therefore, the to-be-annealed work-piece 25 is changed to an annealed work-piece.

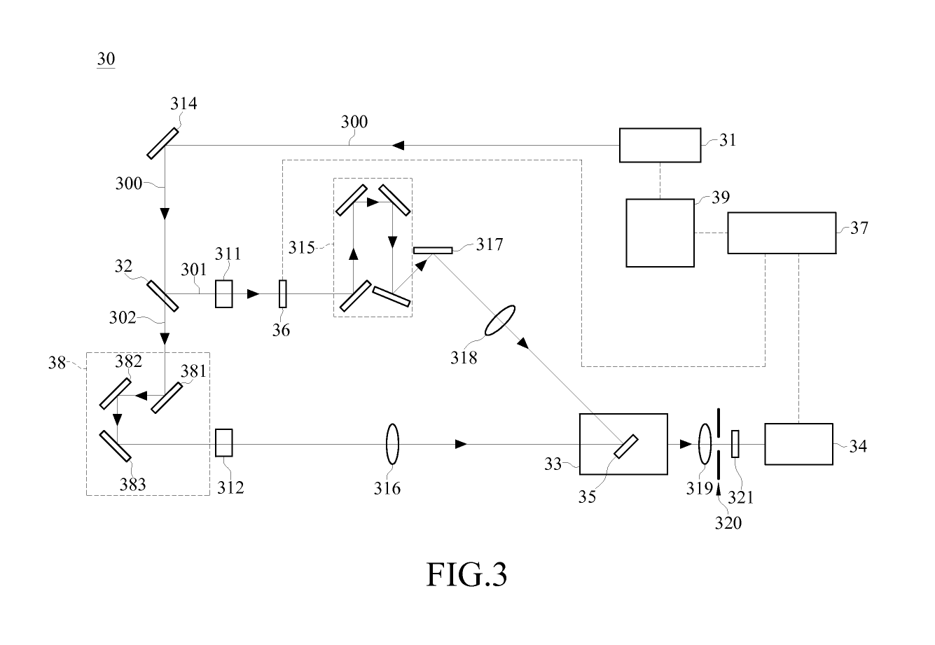

Referring to FIG. 3, it shows a framework of a system 30 of annealing and real-time monitoring by applying laser beam according to another embodiment of the disclosure. The system 30 of annealing and real-time monitoring by applying laser beam of the disclosure comprises a laser source 31, a light splitting element 32, a carrying element 33 and a sensing element 34. The laser source 31 is used for emitting laser beams. The light splitting element 32 is disposed on a beam path 300 of a laser beam and is used for splitting the laser beam into a first light beam travelling along a first path 301 and a second light beam travelling along a second path 302. The carrying element 33 is disposed at an intersecting point of the first path 301 and the second path 302 for carrying a to-be-annealed work-piece 35, and for moving the to-be-annealed work-piece 35 to an annealing position overlaps the intersecting point of the first light beam and the second light beam. The sensing element 34 is disposed adjacent to the carrying element 33, and is used for retrieving a characteristic of changes of properties of matter generated from the second light beam irradiated at the to-be-annealed work-piece 35 or an annealed work-piece. In this embodiment, the sensing element 34 is disposed at a position on the second path 302 passing through the to-be-annealed work-piece 35.

Furthermore, the system 30 further comprises a chopper 36, a locking amplifier 37, an adjusting element 38 and a control element 39. The chopper 36 is disposed on the first path 301 for modulating the first light beam. The locking amplifier 37 is connected to the chopper 36 and the sensing element 34. The locking amplifier 37 is used for processing optical signals of the second light beam modulated by the first light beam. The adjusting element 38 is disposed on the second path 302 and is used for adjusting the beam path length of the second path 302. The control element 39 is connected to the locking amplifier 37 and the adjusting element 38, and is used for controlling the adjusting element 38 to adjust the beam path length of the second path 302 according to a comparison result of the first light beam path length and the second light beam path length. The adjusting element 38 includes, but is not limited to, a plurality of mirrors 381, 382 and 383. The minors 382 and 383 are movably disposed on the second path 302. The beam path length of the second path 302 can be adjusted by the control element 39 by adjusting the positions of the mirrors 382 and 383.

Because the control element 39 is connected to the laser source 31, the emitting of laser beams can be controlled by it. The control element 39 is connected to the carrying element 33 for moving the to-be-annealed work-piece 35 to a position irradiated by the first light beam and the second light beam. The control element 39 is connected to the locking amplifier 37 for determining whether the work-piece is finished with annealing according to the characteristic of changes of properties of matter retrieved by the sensing element 34. The characteristic of changes of properties of matter are, for example, light transmittance or transmitted intensity.

Furthermore, the system 30 further comprises a first laser energy modulator 311 and a second laser energy modulator 312. The first laser energy modulator 311 is disposed on the first path 301 and is used for adjusting a power of the first light beam irradiating at the to-be-annealed work-piece 35. The second laser energy modulator 312 is disposed on the second path 302 and is used for adjusting the power of the second light beam irradiating at the to-be-annealed work-piece 35.

Referring to FIGS. 5A and 5B and cooperating with FIG. 3 for the below descriptions, the method of annealing and real-time monitoring by applying laser beam for using the system 30 in FIG. 3 is described hereafter. FIGS. 5A and 5B are flow charts of the method of annealing and real-time monitoring by applying laser beam according to an embodiment of the disclosure. In step S1, a laser beam emitted by the laser source 31 is a series of pulses with a frequency. The laser beam travels along the beam path 300, and irradiates at the light splitting element 32 after being reflected by a first minor 314. In step S2, the series of pulses are split into a plurality of first pulses of the first light beam and a plurality of second pulses of the second light beam by the light splitting element 32. The first pulses of the first light beam travel along the first path 301 and pass through the first laser energy modulator 311, the chopper 36, a set of second mirrors 315, a third mirror 317 and a first focal lens 318, then irradiating at the to-be-annealed work-piece 35 carried by the carrying element 33. The beam path length of the first path 301 can be adjusted by the set of second minors 315 according to requirements. The chromatic aberration, the focal length and the focus of the first light beam are controlled by first focal lens 318. The second pulses of the second light beam travel along the second path 302 and pass through the adjusting element 38, the second laser energy modulator 312 and a third focal lens 316, then irradiating at the same position of the to-be-annealed work-piece 35 carried by the carrying element 33. The chromatic aberration, the focal length and the focus of the second light beam are controlled by the third focal lens 316. In this embodiment, the light permeable to-be-annealed work-piece 35 is carried by the carrying element 33. The second light beam irradiates a second focal lens 319 by passing through the to-be-annealed work-piece 35, and then irradiates at the sensing element 34 through an iris 320 and a polarizer 321. The focal length of the second light beam can be controlled by the second focal lens 319, and the iris 320 is used for adjusting outputted energy intensities of the first light beam and the second light beam passing through. The polarizer 321 is used for obstructing the passage of the first light beam and letting the second light beam to pass through.

Referring to FIGS. 3, 5A and 5B again, in step S3, checking if a power required for annealing the to-be-annealed work-piece 35 is known by the control element 39. If a value of the power is not known yet, then the process goes to step S10 as shown in FIG. 5B. The characteristic of changes of properties of matter of the to-be-annealed work-piece 35 is an intensity of light transmittance of the second light beam transmitting through the to-be-annealed work-piece 35 retrieved by the sensing element 34. In step S10, the to-be-annealed work-piece 35 is placed on the carrying element 33, and the power of the first light beam is increased gradually from zero by the first laser energy modulator 311. The to-be-annealed work-piece 35 is moved by the carrying element 33 synchronously in corresponding to the increase of the power of the first light beam. In other embodiments, the to-be-annealed work-piece 35 is not moved by the carrying element 3, and a relationship between the intensity of light transmittance and corresponding time and a relationship between the power of the first light beam and corresponding time are recorded. Furthermore, the power of the second light beam is reduced below a certain value by the second laser energy modulator 312 in order to avoid the to-be-annealed work-piece 35 being annealed by the second light beam. Then, the to-be-annealed work-piece 35 is irradiated by the first pulses of the first light beam along the first path 301. In step S11, the to-be-annealed work-piece 35 is irradiated by the second pulses of the second light beam along the second path 302. In step S12, the intensity of light transmittance of the second pulses of the second light beam transmitting through the to-be-annealed work-piece 35 is retrieved by the sensing element 34. Thereby, the to-be-annealed work-piece 35 is irradiated by the second pulses of the second light beam right after the to-be-annealed work-piece 35 is irradiated by the first pulses of the first light beam, so that the effects caused by irradiating at the to-be-annealed work-piece 35 by the first pulses can be retrieved in real-time.

In step S13, in a process of a gradual increase of the power of the first light beam as laser pulses are generated, when a change is occurred in the intensity of light transmittance, recording the power of the first light beam at this moment for the subsequent annealing of the entire to-be-annealed work-piece 35. Furthermore, an initial intensity of light transmittance and a terminal intensity of light transmittance can also be recorded when a change is occurred in the intensity of light transmittance. An average value of the intensity of light transmittance acquired by averaging out the initial intensity of light transmittance and the terminal intensity of light transmittance can be used as a reference for subsequently determining whether the work-piece is finished with annealing. Then, in step S14, the to-be-annealed work-piece 35 is annealed by using a power higher than or equal to the power of the first light beam recorded.

Then, in step S4, the to-be-annealed work-piece 35 is irradiated by the first pulses of the first light beam along the first path 301, so that one of the annealing positions of predetermined areas of the to-be-annealed work-piece 35 is annealed. In this embodiment, the predetermined areas are the positions where the electrically conductive traces are located. In step S5, the same position of the to-be-annealed work-piece 35 is irradiated by the second pulses of the second light beam along the second path 302. In step S6, the intensity of light transmittance of the second pulses of the second light beam irradiating at the to-be-annealed work-piece 35 is retrieved by the sensing element 34. In step S7, it is determined that if the to-be-annealed work-piece 35 is finished with annealing according to the characteristic of changes of properties of matter. The change of properties of matter of most light permeable materials is referred to the intensity of light transmittance being higher than an average value of the intensity of light transmittance after annealing is finished. If a difference between the intensity of light transmittance and the terminal intensity of light transmittance is larger than a difference between an average value of the intensity of light transmittance and the terminal intensity of light transmittance, then the to-be-annealed work-piece 35 is determined to be unfinished with annealing, and then the process goes to step S8. In step S8, parameters of the first light beam are adjusted. For example, the power of the first light beam is increased. Then, the process returns to step S4. In step S4, the annealing position of the to-be-annealed work-piece 35 is irradiated by the first light beam again. If a difference between the intensity of light transmittance and the initial intensity of light transmittance is larger than a difference between an average value of the intensity of light transmittance and the initial intensity of light transmittance, the annealing position of the to-be-annealed work-piece 35 is determined to have finished with annealing, and then the process goes to step S9. In step S9, it is determined that if all the predetermined areas of the to-be-annealed work-piece 35 are finished with annealing. If there are predetermined areas which have not finished with annealing, the process goes to step S9′. In step S9′, an annealing position of the to-be-annealed work-piece 35 is moved by the carrying element 33, and the next annealing position of the to-be-annealed work-piece 35 is annealed by the next first pulse. If all the predetermined areas of the to-be-annealed work-piece 35 are finished with annealing, the annealing process of the to-be-annealed work-piece 35 is finished and therefore, the to-be-annealed work-piece 35 is changed to an annealed work-piece.

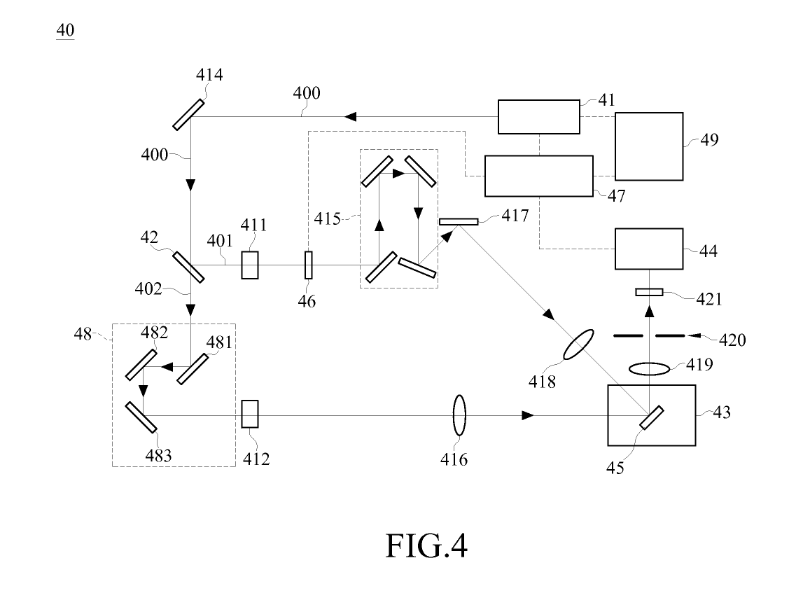

Referring to FIG. 4, it shows a framework of a system 40 of annealing and real-time monitoring by applying laser beam according to another embodiment of the disclosure. The system 40 of annealing and real-time monitoring by applying laser beam of the disclosure comprises a laser source 41, a light splitting element 42, a carrying element 43 and a sensing element 44. The laser source 41 is used for emitting laser beams. The light splitting element 42 is disposed on a beam path 400 of a laser beam and is used for splitting the laser beam into a first light beam travelling along a first path 401 and a second light beam travelling along a second path 402. The carrying element 43 is disposed at an intersecting point of the first path 401 and the second path 402 for carrying a to-be-annealed work-piece 45, and for moving the to-be-annealed work-piece 45 to an annealing position overlaps the intersecting point of the first light beam and the second light beam. The sensing element 44 is disposed adjacent to the carrying element 43, and is used for retrieving a characteristic of changes of properties of matter generated from the second light beam irradiated at the to-be-annealed work-piece 45 or an annealed work-piece. In this embodiment, the sensing element 44 is disposed on the second path 402 at a position where it is reflected by the to-be-annealed work-piece 45.

Furthermore, the system 40 further comprises a chopper 46, a locking amplifier 47, an adjusting element 48 and a control element 49. The chopper 46 is disposed on the first path 401 for modulating the first light beam. The locking amplifier 47 is connected to the chopper 46 and the sensing element 44. The locking amplifier 47 is used for processing optical signals of the second light beam modulated by the first light beam. The adjusting element 48 is disposed on the second path 402 and is used for adjusting the beam path length of the second path 402. The control element 49 is connected to the locking amplifier 47 and the adjusting element 48, and is used for controlling the adjusting element 48 to adjust the beam path length of the second path 402 according to a comparison result of the first light beam path length and the second light beam path length. The adjusting element 48 includes, but is not limited to, a plurality of minors 481, 482 and 483. The mirrors 482 and 483 are movably disposed on the second path 402. The beam path length of the second path 402 can be adjusted by the control element 49 by adjusting the positions of the minors 482 and 483.

Because the control element 49 is connected to the laser source 41, the emitting of laser beams can be controlled by it. The control element 49 is connected to the carrying element 43 for moving the to-be-annealed work-piece 45 to a position irradiated by the first light beam and the second light beam. The control element 49 is connected to the locking amplifier 47 for determining whether the work-piece is finished with annealing according to the characteristic of changes of properties of matter retrieved by the sensing element 44. The characteristic of changes of properties of matter is, for example, reflectivity or intensity of reflection.

Furthermore, the system 40 further comprises a first laser energy modulator 411 and a second laser energy modulator 412. The first laser energy modulator 411 is disposed on the first path 401 and is used for adjusting a power of the first light beam irradiating at the to-be-annealed work-piece 45. The second laser energy modulator 412 is disposed on the second path 402 and is used for adjusting a power of the second light beam irradiating at the to-be-annealed work-piece 45.

Referring to FIGS. 5A and 5B and cooperating with FIG. 4 for the below descriptions, the method of annealing and real-time monitoring by applying laser beam for using the system 40 in FIG. 4 is described hereafter. FIGS. 5A and 5B are flow charts of the method of annealing and real-time monitoring by applying laser beam according to an embodiment of the disclosure. In step S1, a laser beam emitted by the laser source 41 is a series of pulses with a frequency. The laser beam travels along the beam path 400, and irradiates at the light splitting element 42 after being reflected by a first minor 414. In step S2, the series of pulses is split into a plurality of first pulses of the first light beam and a plurality of second pulses of the second light beam by the light splitting element 42. The first pulses of the first light beam travel along the first path 101 and pass through the first laser energy modulator 411, the chopper 46, a set of second mirrors 415, a third mirror 417 and a first focal lens 418, then irradiating at the to-be-annealed work-piece 45 carried by the carrying element 43. The beam path length of the first path 401 can be adjusted by the set of second minors 415 according to requirements. The chromatic aberration, the focal length and the focus of the first light beam are controlled by the first focal lens 418. The second pulses of the second light beam travel along the second path 402 and pass through the adjusting element 48, the second laser energy modulator 412 and a third focal lens 416, then irradiating at the same position of the to-be-annealed work-piece 45 carried by the carrying element 43. The chromatic aberration, the focal length and the focus of the second light beam are controlled by the third focal lens 416. The second light beam is reflected to a second focal lens 419 by the to-be-annealed work-piece 45, and then irradiated at the sensing element 44 through an iris 420 and a polarizer 421. The focal length of the second light beam can be controlled by the second focal lens 419, and the iris 420 is used for adjusting an intensity of capacity of the first light beam and the second light beam passing through. The polarizer 421 is used for obstructing the passage of the first light beam and letting the second light beam to pass through.

Referring to FIGS. 4, 5A and 5B again, in step S3, checking if a power required for annealing the to-be-annealed work-piece 45 is known by the control element 49. If a value of the power is not known yet, then the process goes to step S10 shown in FIG. 5B. The changes of the property of matter of the to-be-annealed work-piece 45 is an intensity of reflection of the second light beam being reflected by the to-be-annealed work-piece 45 retrieved by the sensing element 44. In step S10, the to-be-annealed work-piece 45 is placed on the carrying element 43, and the power of the first light beam is increased gradually from zero by the first laser energy modulator 411. The to-be-annealed work-piece 45 is moved by the carrying element 43 synchronously in corresponding to an increase of the power of the first light beam. In other embodiments, the to-be-annealed work-piece 45 is not moved by the carrying element 43, and a relationship between the intensity of light transmittance and corresponding time and a relationship between the power of the first light beam and corresponding time are recorded Furthermore, the power of the second light beam is reduced below a certain value by the second laser energy modulator 412 in order to avoid the to-be-annealed work-piece 45 being annealed by the second light beam. Then, the to-be-annealed work-piece 45 is irradiated by the first pulses of the first light beam along the first path 401. In step S11, the to-be-annealed work-piece 45 is irradiated by the second pulses of the second light beam along the second path 402. In step S12, the intensity of reflection of the second pulses of the second light beam being reflected by the to-be-annealed work-piece 45 is retrieved by the sensing element 44. Thereby, the to-be-annealed work-piece 45 is irradiated by the second pulses of the second light beam right after the to-be-annealed work-piece 45 is irradiated by the first pulses of the first light beam, so that the effects caused by irradiating at the to-be-annealed work-piece 45 by the first pulses can be retrieved in real-time.

In step S13, in a process of a gradual increase of the power of the first light beam as laser pulses are generated, when a change is occurred in the intensity of reflection, recording the power of the first light beam at this moment for the subsequent annealing of the entire to-be-annealed work-piece 45. Furthermore, an initial intensity of reflection and a terminal intensity of reflection can also be recorded when a change is occurred in the intensity of reflection. An average value of the intensity of reflection acquired by averaging out the initial intensity of reflection and the terminal intensity of reflection can be used as a reference for subsequently determining whether the work-piece is finished with annealing. Then, in step S14, the to-be-annealed work-piece 45 is annealed by using a power higher than or equal to the power of the first light beam recorded.

Then, in step S4, the to-be-annealed work-piece 45 is irradiated by the first pulses of the first light beam along the first path 401, so that one of the annealing positions of predetermined areas of the to-be-annealed work-piece 45 is annealed. In this embodiment, the predetermined areas are the positions where the electrically conductive traces are located. In step S5, the same position of the to-be-annealed work-piece 45 is irradiated by the second pulses of the second light beam along the second path 402. In step S6, the intensity of reflection of the second pulses of the second light beam irradiating at the to-be-annealed work-piece 45 is retrieved by the sensing element 44. In step S7, it is determined that if the to-be-annealed work-piece 45 is finished with annealing according to a characteristic of changes of properties of matter. The change of properties of matter of some reflecting materials is referred to the intensity of reflection being higher than an average value of the intensity of reflection after annealing is finished, but the change of properties of matter of some reflecting materials is referred to the intensity of reflection being lower than an average value of the intensity of reflection after annealing is finished. If a difference between the intensity of reflection and the terminal intensity of reflection is larger than a difference between an average value of the intensity of reflection and the terminal intensity of reflection, then the to-be-annealed work-piece 45 is determined to be unfinished with annealing, and then the process goes to step S8. In step S8, parameters of the first light beam are adjusted. For example, the power of the first light beam is increased. Then, the process returns to step S4. In step S4, the annealing position of the to-be-annealed work-piece 45 is irradiated by the first light beam again. If a difference between the intensity of reflection and the initial intensity of reflection is larger than a difference between an average value of the intensity of reflection and the initial intensity of reflection, the annealing position of the to-be-annealed work-piece 45 is determined to have finished with annealing, and the process goes to step S9. In step S9, it is determined that if all the predetermined areas of the to-be-annealed work-piece 45 are finished with annealing. If there are predetermined areas which have not finished with annealing, the process goes to step S9′. In step S9′, an annealing position of the to-be-annealed work-piece 45 is moved by the carrying element 43, and the next annealing position of the to-be-annealed work-piece 45 is annealed by the next first pulse. If all the predetermined areas of the to-be-annealed work-piece 45 are finished with annealing, the annealing process of the to-be-annealed work-piece 45 is finished and therefore, the to-be-annealed work-piece 45 is changed to an annealed work-piece.

As a conclusion from the above, according to the method and system of annealing and real-time monitoring by applying laser beam of the disclosure, the laser beam is split into the first light beam and the second light beam by the light splitting element. The to-be-annealed work-piece is crystallized after being annealed by the first light beam. The work-piece which has been irradiated by the first light beam is irradiated by the second light beam in order to retrieve in real-time a characteristic of changes of properties of matter generated. Because there are significant a characteristic of changes of properties of matter generated in the non-crystallized and crystallized work-pieces when they are irradiated by the second light beam, whether the work-piece is sufficiently annealed can be known in real-time by sensing the a characteristic of changes of properties of matter retrieved in real-time. Because a status of the work-piece can be known in real-time during the process of annealing, if the work-piece is not sufficiently annealed after being irradiated by the first light beam, parameters of the first light beam, such as a power, etc., can be adjusted, and the work-piece can be annealed again at once, without having to wait to be inspected and tested after various processing. Therefore, all the finished work-pieces are crystallized without defects. Therefore, wasted materials, chemicals, energy and processing hours caused by annealing defects can be avoided, and the effects of reduction of costs and enhancement of defect-free rate can be achieved.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A method of annealing and real-time monitoring by applying laser beam, comprising steps of:
a laser beam being emitted;
the laser beam being split into a first light beam and a second light beam;
the first light beam being irradiated along a first path at a to-be-annealed work-piece for annealing the to-be-annealed work-piece;
the second light beam being irradiated along a second path at the to-be-annealed work-piece;
the to-be-annealed work-piece being changed to an annealed work-piece after the process of annealing is completed for the to-be-annealed work-piece; and
a characteristic of changes of properties of matter being retrieved, wherein the characteristic of changes of properties of matter is generated from the second light beam irradiated at the to-be-annealed work-piece and the annealed work-piece.

2. The method as claimed in claim 1, further comprising the to-be-annealed work-piece being moved to an annealing position irradiated by the first light beam and the second light beam.

3. The method as claimed in claim 1, further comprising the first light beam and the second light beam being converged to a light converging element, and then the first light beam and the second light beam being irradiated at a same position of the to-be-annealed work-piece.

4. The method as claimed in claim 3, further comprising after the first light beam and the second light beam are converged to the light converging element, the first light beam and the second light beam passing through a beam splitter and then irradiating at the to-be-annealed work-piece, the second light beam irradiating at the beam splitter after being reflected by the to-be-annealed work-piece and the annealed work-piece, and then being reflected to a sensing element by the beam splitter in order to retrieve the a characteristic of changes of properties of matter generated from the second light beam being irradiated at the to-be-annealed work-piece and the annealed work-piece.

5. The method as claimed in claim 1, further comprising an beam path length of the second path being adjusted to be longer than an beam path length of the first path after the laser beam is split into the first light beam and the second light beam.

6. The method as claimed in claim 1, further comprising after the a characteristic of changes of properties of matter generated from the second light beam irradiated at the to-be-annealed work-piece and the annealed work-piece is retrieved, whether the to-be-annealed work-piece irradiated by the first light beam being finished with annealing being determined according to the a characteristic of changes of properties of matter; if the to-be-annealed work-piece is not finished with annealing, then a parameter of the first light beam being adjusted, and the first light beam being irradiated at the to-be-annealed work-piece along the first path in order to process annealing for the to-be-annealed work-piece.

7. The method as claimed in claim 1, wherein the characteristic of changes of properties of matter is either light transmittance or reflectivity.

8. The method as claimed in claim 1, before the to-be-annealed work-piece being annealed by the first light beam, further comprising following steps of:
the first light beam being irradiated at the to-be-annealed work-piece along the first path, and a power of the first light beam being increased from zero;
the second light beam being irradiated at the to-be-annealed work-piece along the second path;
the a characteristic of changes of properties of matter, which is generated from the second light beam irradiated at the to-be-annealed work-piece, being retrieved;
as the power of the first light beam being increased, when a change is occurred in the a characteristic of changes of properties of matter, the power of the first light beam at that moment being recorded; and
the to-be-annealed work-piece being annealed by using a power higher than or equal to the power of the first light beam recorded.

9. The method as claimed in claim 1, wherein the step of annealing the to-be-annealed work-piece by the first light beam further includes a position of the to-be-annealed work-piece being adjusted.

10. The method as claimed in claim 1, wherein the laser beam is a series of pulses with a frequency, and the step of splitting the laser beam further comprises the laser beam being split into the first light beam with a plurality of first pulses and the second light beam with a plurality of second pulses.

11. The method as claimed in claim 1, further comprising the step of after the laser beam is split, the first light beam being modulated, and optical signals of the second light beam modulated by the first light beam being processed.

12. The method as claimed in claim 1, further comprising step of after splitting the laser beam into the first light beam and the second light beam, chromatic aberrations of the first light beam and the second light beam being corrected, and a focal length and a focus of the first light beam and the second light beam to the to-be-annealed work-piece being adjusted.

13. The method as claimed in claim 1, further comprising step of after the first light beam and the second light beam at the to-be-annealed work-piece is irradiated, a focus of the second light beam to a sensing element being adjusted.

14. The method as claimed in claim 1, further comprising step of after the first light beam and the second light beam are irradiated at the to-be-annealed work-piece, energy intensities of the first light beam and the second light beam irradiating at the sensing element being adjusted.

15. The method as claimed in claim 1, further comprising the step of after the first light beam and the second light beam are irradiated at the to-be-annealed work-piece, the first light beam and letting the second light beam irradiating at the sensing element being obstructed.

16. A system of annealing and real-time monitoring by applying laser beam, comprising:
a laser source used to emit a laser beam;
a light splitting element disposed on a path of the laser beam for splitting the laser beam into a first light beam travelling along a first path and a second light beam travelling along a second path;
a carrying element disposed on the first path and the second path for carrying a to-be-annealed work-piece or an annealed work-piece, and to move the to-be-annealed work-piece to a position irradiated by the first light beam; and
a sensing element disposed adjacent to the carrying element for retrieving a characteristic of changes of properties of matter generated from the second light beam is irradiated at the to-be-annealed work-piece and the annealed work-piece.

17. The system as claimed in claim 16, further comprising a control element connected to the laser source, the carrying element and the sensing element, and the control element being configured to control emitting of the laser beam, to control the first light beam and the second light beam irradiating at a position of the to-be-annealed work-piece, and to determine whether the to-be-annealed work-piece being finished with annealing according to the a characteristic of changes of properties of matter retrieved by the sensing element.

18. The system as claimed in claim 16, further comprising a light converging element disposed at an intersecting point of the first path and the second path for converging the first light beam and the second light beam to irradiate at the to-be-annealed work-piece.

19. The system as claimed in claim 18, further comprising a beam splitter disposed between the light converging element and the carrying element, the first light beam and the second light beam converged by the light converging element being configured to pass through the beam splitter and irradiate at the to-be-annealed work-piece, the second light beam being configured to irradiated at the beam splitter after being reflected by the to-be-annealed work-piece and the annealed work-piece, and being reflected to the sensing element by the beam splitter.

20. The system as claimed in claim 18, wherein the sensing element is disposed at a position on the first path and the second path penetrating through the to-be-annealed work-piece.

21. The system as claimed in claim 16, further comprising an adjusting element disposed on the second path and being used to adjust a beam path length of the second path.

22. The system as claimed in claim 16, further comprising a chopper disposed on the first path and being used to modulate the first light beam.

23. The system as claimed in claim 22, further comprising a locking amplifier connected to the chopper and the sensing element for processing an optical signal of the second light beam modulated by the first light beam.

24. The system as claimed in claim 23, further comprising a control element connected to the locking amplifier and an adjusting element disposing on the second path, and the control element being configured to control the adjusting element to adjust a beam path length of the second path according to a comparison result of the first light beam path length and the second light beam path length.

25. The system as claimed in claim 24, wherein the adjusting element comprises a plurality of mirrors, at least one of the minors is movably disposed on the second path for adjusting a beam path length of the second path.

26. The system as claimed in claim 16, further comprising a first laser energy modulator and a second laser energy modulator disposed on the first path and the second path respectively for adjusting a power of the first light beam irradiating at the to-be-annealed work-piece and a power of the second light beam irradiating at the to-be-annealed work-piece respectively.

27. The system as claimed in claim 16, wherein the characteristic of changes of properties of matter is either light transmittance or reflectivity.

28. The system as claimed in claim 16, wherein the laser beam emitted by the laser source is a series of pulses with a frequency, the light splitting element is configured to split the pulses into a plurality of first pulses of the first light beam and a plurality of second pulses of the second light beam.

29. The system as claimed in claim 16, further comprising a focal lens disposed on the first path or the second path or on both of them, and being disposed between the light splitting element and the carrying element to control a chromatic aberration, a focal length or a focus of at least one of the first light beam and the second light beam.

30. The system as claimed in claim 16, further comprising:
a focal lens disposed on the second path and between the carrying element and the sensing element for controlling a focal length of the second light beam;
an iris disposed between the carrying element and the sensing element for adjusting an energy intensity of the first light beam and the second light beam passing through; and
a polarizer disposed between the carrying element and the sensing element for obstructing the first light beam and let the second light beam to pass through.
